(19) United States
(12) Patent Application Publication
(10) Pub. No.: US 2016/0209224 A1
(43) Pub. Date: Jul. 21, 2016

(54) VEHICLE SWAP AND DRIVER STATISTICS

(71) Applicant: Myine Electronics, Inc., Ferndale, MI (US)

(72) Inventors: Justin Dickow, Royal Oak, MI (US); Corey Maylone, Berkley, MI (US); John Shutko, Ann Arbor, MI (US); Kathleen Blackmore, Northville, MI (US); Shun-an Chung, Sunnyvale, CA (US); Wesley Laylin Johnson, Watertown, MA (US)

(21) Appl. No.: 14/597,874

(22) Filed: Jan. 15, 2015

(51) Int. Cl. G01C 21/34

(52) U.S. Cl. CPC G01C 21/3438

(57) ABSTRACT

A ride-swap server may receive vehicle location information; and when vehicle swap information indicates a pending vehicle swap between a first vehicle assigned to a first user and a second vehicle assigned to a second user, provide a location of the first vehicle to a mobile device of the second user and provide a location of the second vehicle to a mobile device of the first user. A vehicle information server may receive vehicle information from a plurality of vehicles; identify, according to vehicle swap information, a swap start time of a user swapping from a first vehicle to a second vehicle; and compile driving statistics for the user using the vehicle information from the first vehicle before the swap start time and from the second vehicle after the swap start time.

### TECHNICAL FIELD

Aspects of the disclosure generally relate to facilitating the swapping of vehicles between drivers, as well as the tracking of driver behavior across multiple vehicles.

### BACKGROUND

In some cases, a driver may wish to temporarily switch vehicles. As an example, the driver may wish to borrow a friend's truck to move an object that may not fit within the driver's vehicle. However, it may be difficult for the driver to find a vehicle available to be borrowed. Moreover, the vehicle to be borrowed may not be conveniently or readily located.

### SUMMARY

In a first illustrative embodiment, a ride-swap server may receive vehicle location information; and when vehicle swap information indicates a pending vehicle swap between a first vehicle assigned to a first user and a second vehicle assigned to a second user, provide a location of the first vehicle to a mobile device of the second user and provide a location of the second vehicle to a mobile device of the first user.

In a second illustrative embodiment, a vehicle information server may receive vehicle information from a plurality of vehicles; identify, according to vehicle swap information, a start indication of a user swapping from a first vehicle to a second vehicle; and compile driving statistics for the user using the vehicle information from the first vehicle before the start indication and from the second vehicle after the start indication.

In a third illustrative embodiment, a mobile device associated with a user account may send, to a server, an acceptance of a vehicle swap describing a swap of a vehicle associated with the user account with a second vehicle associated with a second user account; and display a location of the second vehicle received from the server when a start time of the vehicle swap is within a predetermined threshold from a current time.

### BRIEF DESCRIPTION OF THE DRAWINGS

FIG. 1 illustrates an example system including a vehicle implementing vehicle swap and driver monitoring features;

FIG. 2 illustrates an example user interface for viewing a listing of vehicle swap information;

FIG. 3 illustrates an example user interface details of vehicle swap information;

FIG. 4 illustrates an example user interface for locating a vehicle with which to swap;

FIG. 5 illustrates an example user interface for filtering the search list;

FIG. 6 illustrates an example user interface for viewing details of a vehicle;

FIGS. 7A and 7B illustrate an example user interface for requesting a vehicle swap;

FIG. 8 illustrates an example user interface for viewing completed vehicle swaps;

FIG. 9 illustrates an example user interface for configuring account information of a user;

FIG. 10 illustrates an example user interface for configuring vehicles associated with the user;

FIG. 11 illustrates an example state diagram for the swap status of a vehicle swap information managed by the swap management server;

FIG. 12 illustrates an example process for collecting vehicle information;

FIG. 13 illustrates an example process for performing a vehicle swap; and

FIG. 14 illustrates an example process for compiling driver statistics across swapped vehicles.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A vehicle system may be configured to support ride swapping features in which drivers may search for vehicles to swap, and may request for other drivers to approve to swap vehicles. The system may include a mobile application installed to a driver's mobile device, and a swap management server configured to maintain information regarding assignment of vehicles to users in the system. The application may be configured to access the swap management server to search available vehicles, as well as to request another user of the system to swap vehicles for a period of time.

The vehicles may be further configured to send data and location updates about the vehicle to a vehicle information server. In an example, the vehicle may include a data adapter dongle device connected to an on-board diagnostics II (OBD-II) or other vehicle data port and configured to receive information via the port regarding the vehicle. The data adapter may be configured to send updates to the vehicle information server, where the vehicle information server may aggregate the data from the vehicles. The data may include information (e.g., vehicle speed and pedal position information, etc.) that may be used to determine statistics about the vehicle or vehicle driver. The data may also include information about the identity of the vehicle, such as vehicle identification number (VIN).

Based on the data, the server may be configured to present live or historical information about a vehicle to the user. Moreover, by using the swap management server in combination with the vehicle information server, a manager of the drivers may be able to view driving history of each driver individually, across vehicles, as well as aggregated driving data for the fleet vehicles individually and across drivers. Further aspects of the vehicle swap and driver reporting aspects are discussed in detail below.

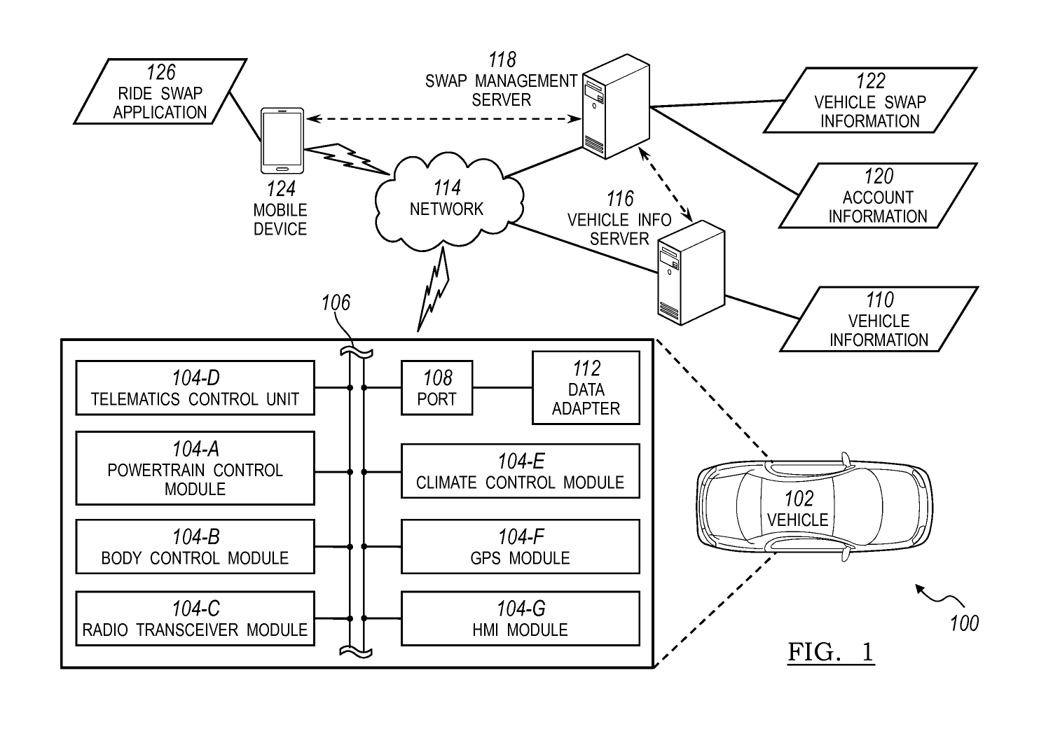

FIG. 1 illustrates an example system 100 including a vehicle 102 implementing vehicle swap and driver monitoring features. As illustrated, the vehicle 102 includes a plurality of vehicle systems 104 in communication over one or more vehicle buses 106. The vehicle further includes a port 108 to which a data adapter 112 is connected to receive vehicle information 110 to provide over a network 114 to a vehicle information server 116. The system 100 further includes a swap management server 118 maintaining account information 120 and vehicle swap information 122, and in communication with one or more mobile devices 124. The mobile devices 124 may be configured to execute a ride swap application 126 to communicate with the swap management server 118 and facilitate the swapping of vehicles 102. The swap management server 118 may further provide reporting functionality. It should be noted that the system 100 is merely an example, and other arrangements or combinations of elements may be used.

The vehicle 102 may include various types of automobile, crossover utility vehicle (CUV), sport utility vehicle (SUV), truck, recreational vehicle (RV), boat, plane or other mobile machine for transporting people or goods. In many cases, the vehicle 102 may be powered by an internal combustion engine. As another possibility, the vehicle 102 may be a hybrid electric vehicle (HEV) powered by both an internal combustion engine and one or more electric motors, such as a series hybrid electric vehicle (SHEV), a parallel hybrid electrical vehicle (PHEV), or a parallel/series hybrid electric vehicle (PSHEV). As the type and configuration of vehicle 102 may vary, the capabilities of the vehicle 102 may correspondingly vary. As some other possibilities, vehicles 102 may have different capabilities with respect to passenger capacity, towing ability and capacity, and storage volume. For title, inventory, and other purposes, vehicles 102 may be associated with unique identifiers, such as VINs.

The plurality of vehicle systems 104 may be configured to perform various vehicle 102 functions under the power of the vehicle battery and/or drivetrain. As depicted, the example vehicle systems 104 are represented as discrete modules 104-A through 104-G. However, the vehicle systems 104 may share physical hardware, firmware, and/or software, such that the functionality from multiple modules 104 may be integrated into a single module 104, and that the functionality of various such modules 104 may be distributed across a plurality of modules 104.

As some non-limiting vehicle system 104 examples: a powertrain control module 104-A may be configured to provide control of engine 104 operating components (e.g., idle control components, fuel delivery components, emissions control components, etc.) and for monitoring status of such engine operating components (e.g., status of engine fault codes); a body control module 104-B may be configured to manage various power control functions such as exterior lighting, interior lighting, keyless entry, remote start, and point of access status verification (e.g., closure status of the hood, doors and/or trunk of the vehicle 102); a radio transceiver module 104-C may be configured to communicate with key fobs, mobile devices 124, or other local vehicle 102 devices; a telematics control unit 104-D may be configured to send and receive commands over a wireless network connection (e.g., via network 114); a climate control management module 104-E may be configured to provide control of heating and cooling system components (e.g., compressor clutch, blower fan, temperature sensors, etc.); a global positioning system (GPS) module 104-F may be configured to provide vehicle location information; and a human-machine interface (HMI) module 104-G may be configured to provide vehicle status information to a driver, such as fuel level info, engine operating temperature information, and current location of the vehicle 102.

The vehicle bus 106 may include various method of communication available between the system modules 104, as well as between the vehicle port 108 and the system modules 104. As some non-limiting examples, the vehicle bus 106 may include one or more of a vehicle controller area network (CAN), an Ethernet network, and a media oriented system transfer (MOST) network.

The vehicle port 108 may include one or more interfaces from which vehicle information 110 may be supplied to devices. In an example, the vehicle port 108 may be an OBD-II port configured to facilitate the capture of information from the system modules 104 connected to the vehicles bus 106. The data adapter 112 may be configured to connect to the vehicle port 108 to receive the vehicle information 110. The vehicle information 110 retrieved by the data adapter 112 may include, as some non-limiting examples, accelerator pedal position, steering wheel angle, vehicle speed, vehicle location (e.g., GPS coordinates, etc.), vehicle unique identifier (e.g., VIN), and vehicle HMI information, such as steering wheel button press information.

The data adapter 112 may include one or more processors or microprocessors configured to execute firmware or software programs stored on one or more memory devices of the data adapter 112. The data adapter 112 may further include network hardware configured to facilitate communication with other devices of the system 100. For example, the data adapter 112 may include a cellular modem configured to facilitate communication with the communications network 114. The network 114 may include one or more interconnected communication networks such as the Internet, a cable television distribution network, a satellite link network, a local area network, a wide area network, and a telephone network, as some non-limiting examples. As another example, the data adapter 112 one or more of Bluetooth, Wi-Fi, and wired USB network connectivity to facilitate communication with the communications network 114 via the mobile device 124. In an example, the data adapter 112 may be programmed to periodically provide the vehicle information 110 to the vehicle information server 116 over the communications network 114.

The vehicle information server 116 may include various types of computing apparatus, such as a computer workstation, a server, a desktop computer, a virtual server instance executed by a mainframe server, or some other computing system and/or device. Computing devices, such as the vehicle information server 116, generally include a memory on which computer-executable instructions may be maintained, where the instructions may be executable by one or more processors of the computing device. Such instructions and other data may be stored using a variety of computer-readable media. A computer-readable medium (also referred to as a processor-readable medium or storage) includes any non-transitory (e. g., tangible) medium that participates in providing data (e.g., instructions) that may be read by a computer (e.g., by the processor of the vehicle information server 116). In general, processors receives instructions, e.g., from the memory via the computer-readable storage medium, etc., and executes these instructions, thereby performing one or more processes, including one or more of the processes described herein. Computer-executable instructions may be compiled or interpreted from computer programs created using a variety of programming languages and/or technologies, including, without limitation, and either alone or in combination, Java, C, C++, C#, Objective C, Fortran, Pascal, Visual Basic, Java Script, Perl, Python, PL/SQL, etc. In an example, the vehicle information server 116 may be configured to maintain the vehicle data 110 received from the data adapters 112 of the vehicles 102 by way of the network 114.

The account information 120 may include information regarding authorized users of the system 100. For example, the account information 120 may include a unique account or username identifier, and information regarding a vehicle 102 owned by and/or otherwise assigned to the user (e.g., according to VIN or other vehicle identifier). The information about the vehicles 102 may include vehicle configuration information such as make, model, color, and stock photos, as some possibilities. In one example, the information about the vehicles 102 may be determined by the vehicle information server 116 according to a VIN lookup of the vehicles 102 with a manufacturer or other source of information for vehicles 102. The account information 120 may further include authentication information, such as login names, passwords, encryption keys, challenge questions, or other information that may be used to authenticate users with the system 100.

The vehicle swap information 122 may include information regarding a user's planned (and in some cases historical) vehicle 102 swaps. The vehicle swaps information 122 may include, for example, unique account identifiers of users swapping vehicles 102, vehicle 102 identifiers of users swapping vehicles 102, a time period during which the swap is scheduled to take place or did take place (e.g., a start time, an end time), a swap status (e.g., requested/unaccepted, changed, accepted, declined, canceled, started or in progress, ended or completed, etc.) and other information or notes regarding the vehicle 102 swap.

Similar to as discussed above with respect to the vehicle information server 116, the swap management server 118 may include various types of computing apparatus including a memory on which computer-executable instructions may be maintained, where the instructions may be executable by one or more processors of the computing device. The swap management server 118 may be configured to maintain the account information 120 and the vehicle swap information 122, as well as to facilitate the vehicle 102 swaps in combination with the ride swap application 126 executed by the mobile devices 124.

The swap management server 118 may be further configured to identify, according to vehicle swap information 122, when a user may be driving which vehicles 102, and access the vehicle information 110 maintained by the vehicle information server 116 to retrieve the logged vehicle information 110 across the vehicles 102 driven by the user. For example, the swap management server 118 may receive an identifier of account information 120 to query, and may determine, based on the vehicle swap information 122, which vehicles 102 were associated with the account information 120 at what times. The swap management server 118 may be further configured to query the vehicle information server 116 to retrieve the vehicle information 110 associated with the vehicles 102 driven by the user for the times the user utilized those vehicles 102. Using the retrieved vehicle information 110, the swap management server 118 may compile driving statistics for the user indicating the driver's behavior across vehicles 102. Accordingly, using the vehicle swap information 122, the swap management server 118 may determine driver statistics across vehicles 102, while avoiding including vehicle information 110 indicative of usage of the vehicles 102 by other drivers.

The mobile devices 124 may include various devices usable by drivers or other users to access the swap management server 118 over the network 114. Mobile devices 124 may include any of various types of computing devices, such as a personal computer or laptop, a personal digital assistant (PDA), a mobile phone, a tablet device, a microprocessor-based entertainment appliance, a peer-to-peer communication device or some other type of network-enabled device over which computing services may be provided. As one possibility, the mobile device 124 may be an iPhone manufactured by Apple, Inc. of Cupertino, Calif. In an example, the mobile devices 124 may be configured to access the vehicle information server 116 by using a web browser application. As another possibility, the mobile devices 124 may execute the ride swap application 126, or “app”, configured to provide access to the vehicle information server 116. In some cases, the ride swap application 126 may be downloaded from an application store such as the App Store provided by Apple, Inc. of Cupertino, Calif., or the Google Play store provided by Google, Inc. of Mountain View, Calif.

When executed by the mobile devices 124, the ride swap application 126 may be configured to allow the user to search vehicles 102 available for swap, request to swap the user's vehicle 102 for another vehicle 102, accept or reject vehicle 102 swap requests, receive location information for a vehicle 102 to pick up when a vehicle 102 swap is scheduled to occur within a predetermined threshold about of time, confirm that a vehicle 102 swap has occurred, and confirm that a vehicle 102 swap has concluded. Further aspects of the use of the ride swap application 126 are discussed in detail below.

Variations on the system 100 are possible. In an example, instead of or in addition to use of the data adapter 112 connected to the port 108, the system may utilize an in-vehicle modem, such as a modem of the telematics control unit 104-D to perform the collection and providing of vehicle information 110 to the vehicle information server 116 over the communications network 114.

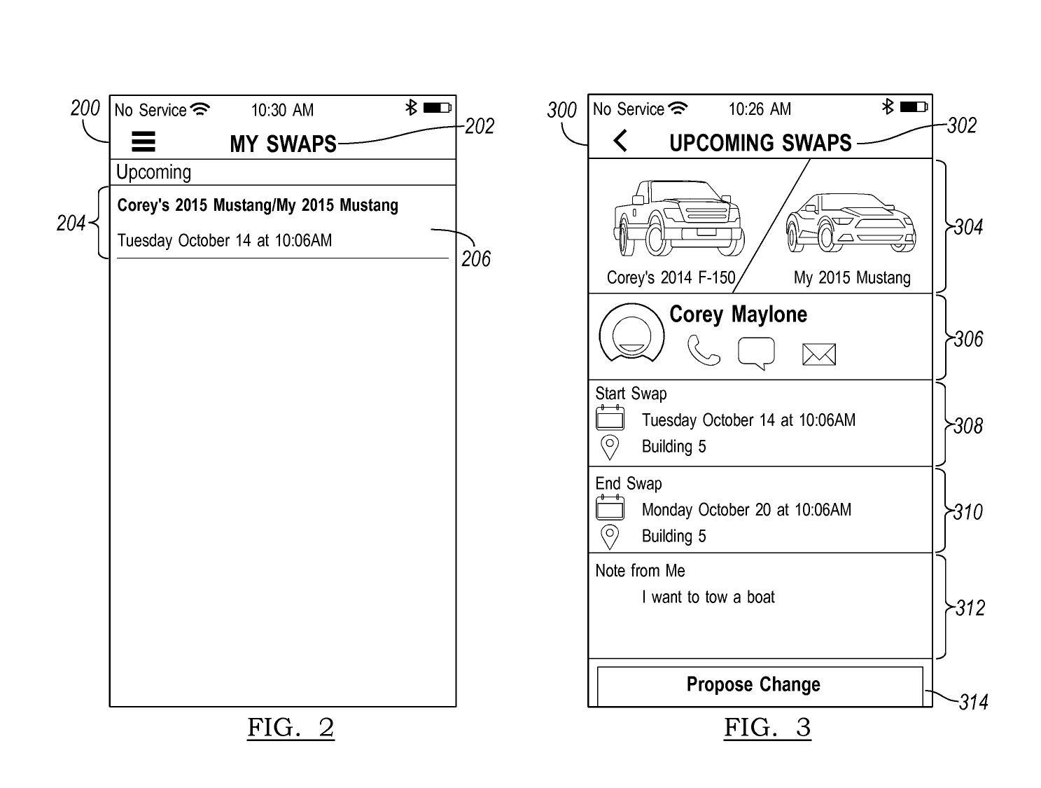

FIG. 2 illustrates an example user interface 200 for viewing a listing of vehicle swap information 122. The user interface 200 may be presented, for example, on a display of the mobile device 124 executing the ride swap application 126 and accessing the swap management server 118. The user interface 200 may be provided by the ride swap application 126, for example, responsive to a user logging into the swap management server 118 using his or her account information 120 credentials. As illustrated, the user interface 200 may be provided by way of a dedicated application, such as the ride swap application 126. In other examples, however, the user interface 200 may be provided by the swap management server 118 as a web page user interface to a mobile device 124 utilizing a web browser application to connect to a universal resource locator (URL) of the swap management server 118.

Regardless of the specific client being used, the user interface 200 may include a title label 202 to indicate to the user that the user interface 200 is for managing the current and upcoming vehicle 102 swaps associated with the user account. The user interface 200 may further include a swap list 204 configured to display selectable indications 206 of the vehicle swap information 122 stored by the swap management server 118 that are available for editing by the logged-in account information 120. As illustrated, the swap list 204 includes an indication 206-A for swap between a user's 2015 Mustang and Corey's 2015 Mustang. The indication 206-A may include summary information regarding the vehicle 102 swap, such as identifiers of the vehicles 102 to be swapped, and time information regarding the vehicle 102 swap (e.g., an upcoming start time for the swap).

When an indication 206 is selected (e.g., by a user of the user interface 200 clicking or touching one of the indications 206), the mobile device 124 executing the ride swap application 126 may send a command via the communications network 114 to the swap management server 118, to cause the swap management server 118 to initiate configuration of the vehicle swap information 122 corresponding to the selected indication 206.

FIG. 3 illustrates an example user interface 300 details of vehicle swap information 122. As with the user interface 200, the user interface 300 may be presented, for example, on the display of the mobile device 124 executing the ride swap application 126 and accessing the swap management server 118. The user interface 300 may be presented, for example, responsive to selection of an indication 206 of vehicle 102 swap from the user interface 200 for editing.

The user interface 300 may include a title label 302 to indicate to the user that the user interface 300 is for editing the selected vehicle swap information 122. The user interface 300 may further include summary information 304 that illustrates the vehicles 102 to be swapped. The vehicle 102 illustrations may include, for example, stock photos of the vehicle 102 models to be swapped. In some cases, the vehicle 102 illustrations may be displayed in the colors of the vehicles 102 to be swapped. The vehicle 102 color and model information may be automatically determined, for example, based on the unique identifier of the vehicle 102 (e.g., according to VIN, according to window sticker looked up from by VIN, etc.), or according to information input into the system descriptive of the vehicles 102 that are available for swapping. In a specific example, the summary information 304 may indicate that a red 2014 model year FORD F-150 truck is being swapped for a red 2015 model year FORD Mustang.

The user interface 300 may include swap party information 306 that may be used contact the user whose vehicle 102 is scheduled to be swapped with the current user. In an example, the swap party information 306 may include an indication of the name of the other party to the swap, as well as a picture of the other party, if available. The swap party information 306 may further include a phone feature configured to allow the user to call the other party, a text feature configured to allow the user to text the other party, an e-mail feature configured to allow the user to e-mail the other party. The name, picture, and contact information for the other party may be retrieved by the ride swap application 126 from the swap management server 118 by querying the account information 120 of the other party associated with the vehicle swap information 122.

The user interface 300 may also include start swap information 308 indicating the time and location of the start of the vehicle 102 swap, end swap information 310 indicating the time and location of the end of the vehicle 102 swap, and any notes 312 added to the vehicle swap information 122 (e.g., a description of the purpose of the swap). The information used to display the start swap information 308, the end swap information 310, and the notes 312 may be identified based on the details of the selected vehicle swap information 122.

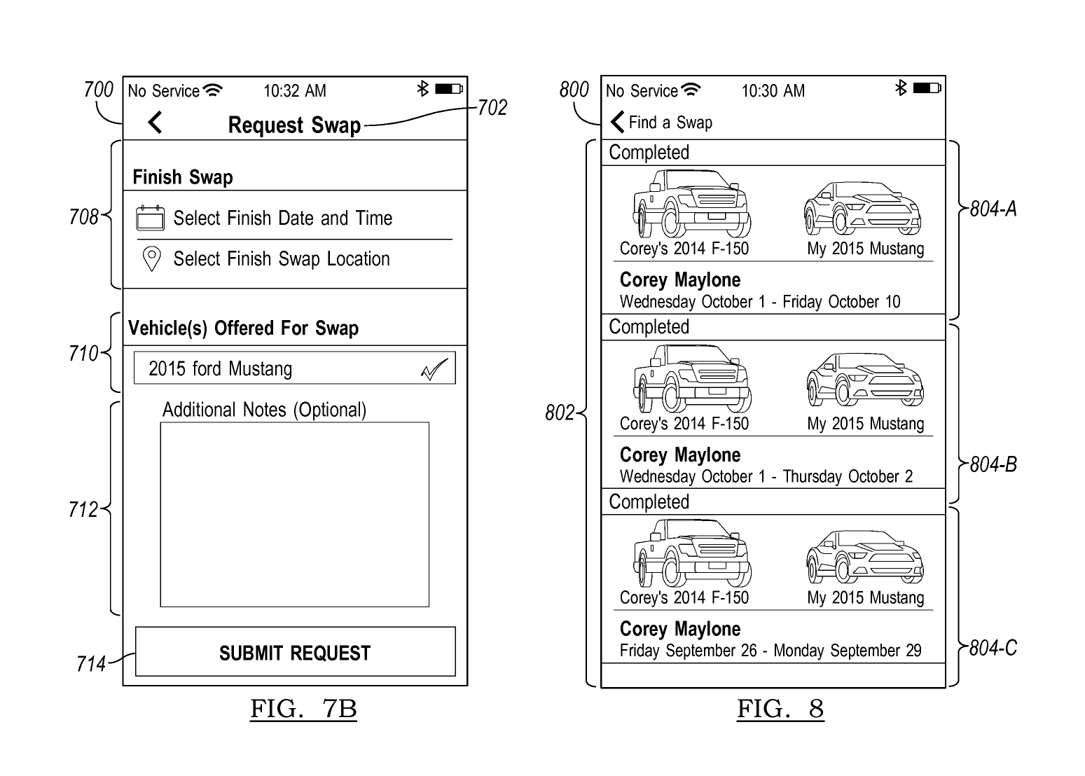

The user interface 300 may also include a propose change control 314, that, when selected, allows the user to request changes to the upcoming swap. Further aspects of configuration of vehicle swap information 122 are discussed in detail below with respect to FIGS. 7A and 7B.

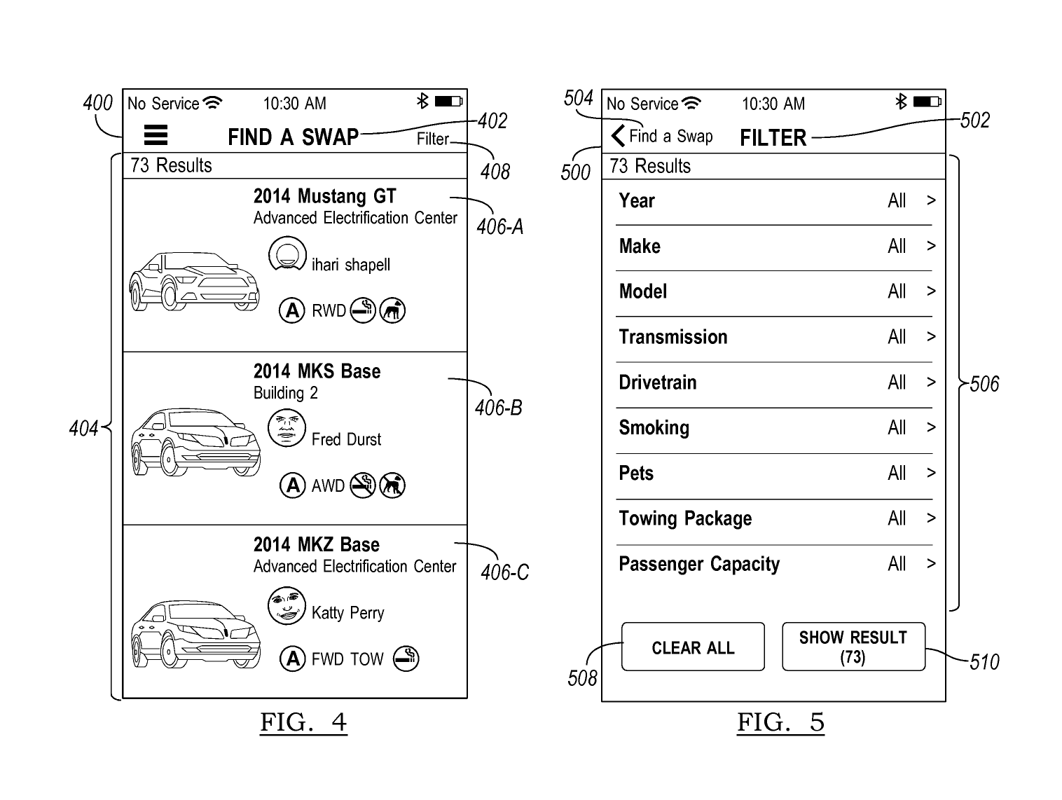

FIG. 4 illustrates an example user interface 400 for locating a vehicle 102 with which to swap. As with the user interfaces 200 and 300, the user interface 400 may be presented, for example, on the display of the mobile device 124 executing the ride swap application 126 and accessing the swap management server 118. The user interface 400 may be presented, for example, responsive to selection of a find a swap feature of the ride swap application 126.

The user interface 400 may include a title label 402 to indicate to the user that the user interface 400 is for searching vehicles 102 for swapping. The user interface 400 may be further configured to display a search list 404 of the system 100 that may be available to request for swapping. In an example, the account information 120 of the user of the ride swap application 126 may specify that the user is a member of a particular vehicle 102 fleet, and the available result vehicles 102 may be those vehicles 102 associated with the same fleet. In another example, the available result vehicles 102 may include any vehicles 102 of the system 100.

The search list 404 may include indications 406 of the available vehicles 102 for swap. Each indication 206 may include an illustration of the vehicle 102 model, a description of the vehicle model, a current location of the vehicle 102, a user currently associated with the vehicle 102. The indications 406 may further include additional information regarding the capabilities of the vehicle 102, such the drive wheels of the vehicle 102 (e.g., front wheel drive, all-wheel drive, rear wheel drive, four wheel drive, etc.), whether the vehicle 102 has towing capability, whether smoking is allowed in the vehicle 102, and whether pets are allowed in the vehicle 102. As illustrated, the indication 406-A relates to a black 2014 Mustang GT located at the Advanced Electrification Center, assigned to Ihari, and that is rear-wheel drive, and where pets and smoking are allowed; the indication 406-B relates to a silver 2014 LINCOLN MKS in Base trim located at Building Two, assigned to Fred, that is all-wheel drive, and where neither pets nor smoking are permitted, and the indication 406-C relates to a silver 2014 LINCOLN MKZ in Base trim located at the Advanced Electrification Center, assigned to Katty, that is front wheel drive, has a tow hitch, and where smoking is permitted.

The search list 404 may be configured to be scrollable to allow a user to locate a vehicle 102 having a desired configuration. The user interface 400 may further include a filter control 408, that, when selected, may cause the ride swap application 126 to facilitate filtering of the available vehicles 102 of the search list 404.

FIG. 5 illustrates an example user interface 500 for filtering the search list 404. As with the user interfaces 200-400, the user interface 500 may be presented, for example, on the display of the mobile device 124 executing the ride swap application 126 and accessing the swap management server 118. The user interface 500 may be presented, for example, responsive to selection of the filter control 408.

The user interface 500 may include a title label 502 to indicate to the user that the user interface 500 is for filtering the search list 404, and a return control 504 that, when selected, allows the user to return to the user interface 400. The user interface 500 may also include a filter list 506 from which a user may select criteria to filter the search list 404. Example criteria may include one or more of vehicle 102 model year, make, model, transmission type, drivetrain type, whether smoking is permitted, whether pets are permitted, whether a towing package is installed, passenger capacity, etc. The user interface may also include a clear all control 508 configured to remote all filter criteria of the filter list 506, and a show results control 510 configured to apply any changes in filter and return to the user interface 400. The label of the show results control 510 may be further configured to dynamically update a number of available vehicles 102 that match the selected filter list 506 criteria.

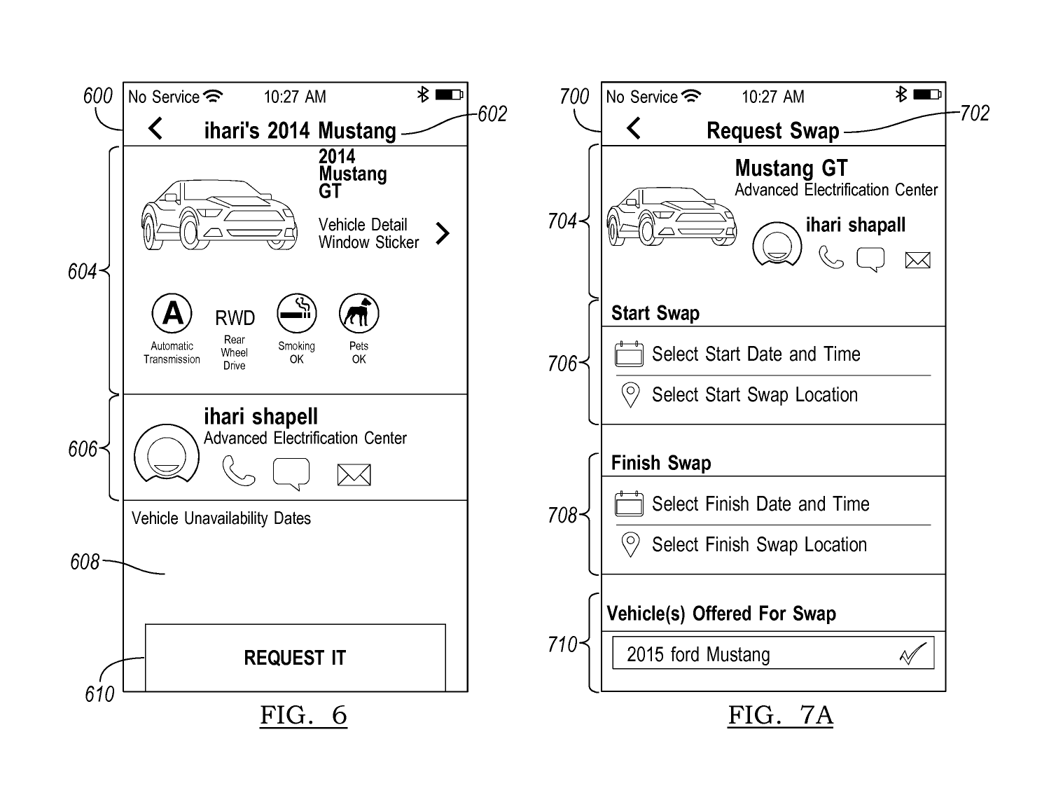

FIG. 6 illustrates an example user interface 600 for viewing details of a vehicle 102. As with the user interfaces 200-500, the user interface 600 may be presented, for example, on the display of the mobile device 124 executing the ride swap application 126 and accessing the swap management server 118. The user interface 600 may be presented, for example, responsive to selection of a vehicle 102 from the search list 404 of the user interface 400.

The user interface 600 may include a title label 602 to indicate to the user the details of the vehicle 102 selected for viewing in the user interface 600. The user interface 600 may further provide vehicle details 604 about the vehicle 102, such as model year, make, model, transmission type, drivetrain type, whether smoking is permitted, whether pets are permitted, whether a towing package is installed, passenger capacity, etc. In some examples, these details may correspond to the information available about the vehicle 102, and/or to the available filter criteria of the filter list 506.

The user interface 600 may further include user details 606 relating to the account information 120 of the user assigned to the vehicle 102, as well a listing of dates or times in which the vehicle 102 is unavailable for swapping (e.g., times when the vehicle 102 is already schedule to be swapped with another user, times when the user assigned to the vehicle 102 requires it for another purpose, etc.). The user interface 600 may also include a request it control 610 that when selected, allows the user to request the user associated with the vehicle 102 to swap vehicles 102.

FIGS. 7A and 7B illustrate an example user interface 700 for requesting a vehicle 102 swap. As with the user interfaces 200-600, the user interface 700 may be presented, for example, on the display of the mobile device 124 executing the ride swap application 126 and accessing the swap management server 118. The user interface 700 may be presented, for example, responsive to selection of the request it control 610 of the user interface 600. In another example, the user interface 700 may be presented responsive to selection of a propose change control 314 of the user interface 300, in which case the user interface 700 may be prepopulated with the current vehicle swap information 122 to be edited.

The user interface 700 may include a title label 702 to indicate to the user that the user interface 700 is for swapping vehicles 102. The user interface 700 may further provide swap summary details 704 about the vehicle 102, such as vehicle 102 make, model, a stock image of the vehicle 102, as well as summary details 704 of the user assigned to the vehicles 102, such as name, picture, and contact information of the user.

The user interface 700 may further include start swap controls 706 configured to receive input from the user on the start date and time for the swap, as well as a location of the vehicles 102 at the start of the vehicle 102 swap. The user interface 700 may also include end swap controls 706 configured to receive input from the user on the end date and time for the swap, as well as a location of the vehicles 102 at the end of the vehicle 102 swap.

As another aspect of the swap definition, the user interface 700 may include an indication of the vehicle 102 being offered by the requester in exchange for the vehicle 102 being requested. In some cases, a user may be associated with multiple vehicles 102 and the user may select which of the vehicles 102 is being offered for swapping. In other cases, the user may be associated with a single vehicle 102, and either no selection may be made available, or a selection from the one vehicle 102 may be provided to illustrate the vehicle 102 that is being requested for swap.

The user interface 700 may also include a notes field 712 into which the user may include text descriptive of a reason or other circumstances surrounding the request. An example of notes entered into the notes field 712 is illustrated above with respect to the notes 312 field of the upcoming swap shown in the user interface 300. Once the user has completed the details of the swap request, the user may select the submit request 714 control to cause the ride swap application 126 to send the swap request to the swap management server 118 for processing. The swap management server 118 may accordingly create a new instance of vehicle swap information 122 with a status of unaccepted.

FIG. 8 illustrates an example user interface 800 for viewing completed vehicle 102 swaps. As with the user interfaces 200-700, the user interface 800 may be presented, for example, on the display of the mobile device 124 executing the ride swap application 126 and accessing the swap management server 118. The user interface 700 may be presented, for example, responsive to selection of a completed swaps item from the user interface of the ride swap application 126.

The user interface 800 may display a completed swaps list 802 of the swaps previously completed by the user. The swap list 804 may include a listing of swap items 806, where each item indicates information regarding the swap, such as the vehicles 102 that were swapped, and the times at which they were swapped. For example, a first swap item 806-A may indicate that a user's vehicle was swapped between October 1^{st} and October 10^{th}, a second swap item 806-B may indicate that a user's vehicle was swapped between October 1^{st} and October 2^{nd}, and a third swap item 806-C may indicate that a user's vehicle was swapped between September 26^{th} and September 29^{th}.

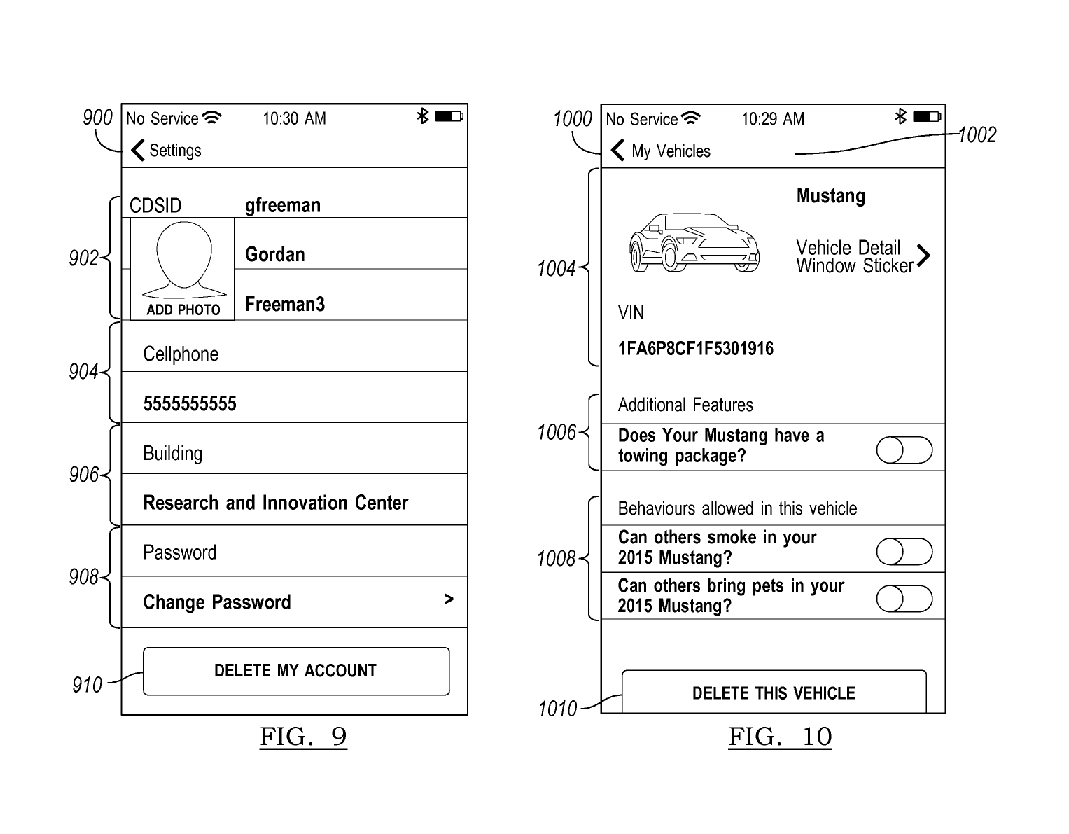

FIG. 9 illustrates an example user interface 900 for configuring account information 120 of a user. As with the user interfaces 200-800, the user interface 900 may be presented, for example, on the display of the mobile device 124 executing the ride swap application 126 and accessing the swap management server 118. The user interface 900 may be presented, for example, responsive to selection to configure the user account. As another possibility, for new users the user interface 900 may be displayed as part of an initial setup sequence.

The user interface 900 may include identification controls 902 configured to allow a user to configure name or other identifying account information 120 regarding the user, such as first name, last name, a picture of the user, and a handle or other unique or shorthand identifier of the user. The user interface 900 may also include contact information controls 904 configured to allow a user to configure information useful for contacting the user, such as phone number, email address, instant messenger address, as some possibilities. The user interface 900 may also include a location identification controls 906 configured to allow a user to enter a default building or other location where the user may be typically located during the day, which may be useful for users generally looking for a user to swap vehicles 102 with in the future. The user interface 900 may also include authentication controls 908 configured to allow the user to configure a password or other credentials used by the system to allow the user to identify with and log into the swap management server 118 (e.g., via the ride swap application 126). If the user no longer wishes to use the system 100, the user may select a delete my account control 910 of the user interface 900 to remove the account information 120 of the user from the storage of the swap management server 118. When changes are input, they may be provided by the ride swap application 126 to update the account information 120.

FIG. 10 illustrates an example user interface 1000 for configuring vehicles 102 associated with the user. As with the user interfaces 200-900, the user interface 1000 may be presented, for example, on the display of the mobile device 124 executing the ride swap application 126 and accessing the swap management server 118. The user interface 1000 may be presented, for example, responsive to selection to configure the vehicles 102 associated with the user account. As another possibility, for new users the user interface 1000 may be displayed as part of an initial setup sequence.

The user interface 1000 may include vehicle information controls 1004 configured to display information regarding the vehicle 102 or selected vehicle 102 associated with the user. Using the vehicle information controls 1004, the user may be able to view information such as vehicle 102 unique identifier (e.g., VIN), vehicle 102 window sticker, vehicle 102 make, vehicle 102 model and vehicle 102 color. The user interface 1000 may include additional feature controls 1006 from which a user may select whether the vehicle 102 has or does not have certain optional features, such as a tow package. The user interface 1000 may also include allowable behavior controls 1008 from which a user may select whether certain behaviors are allowed for the vehicle 102, such as smoking in the vehicle 102 or bringing pets in the vehicle 102. If the user no longer wishes to use the vehicle 102 with the system 100, the user may select a delete this vehicle control 1010 of the user interface 1000 to remove the association of the vehicle 102 with the account information 120 of the user from the storage of the swap management server 118.

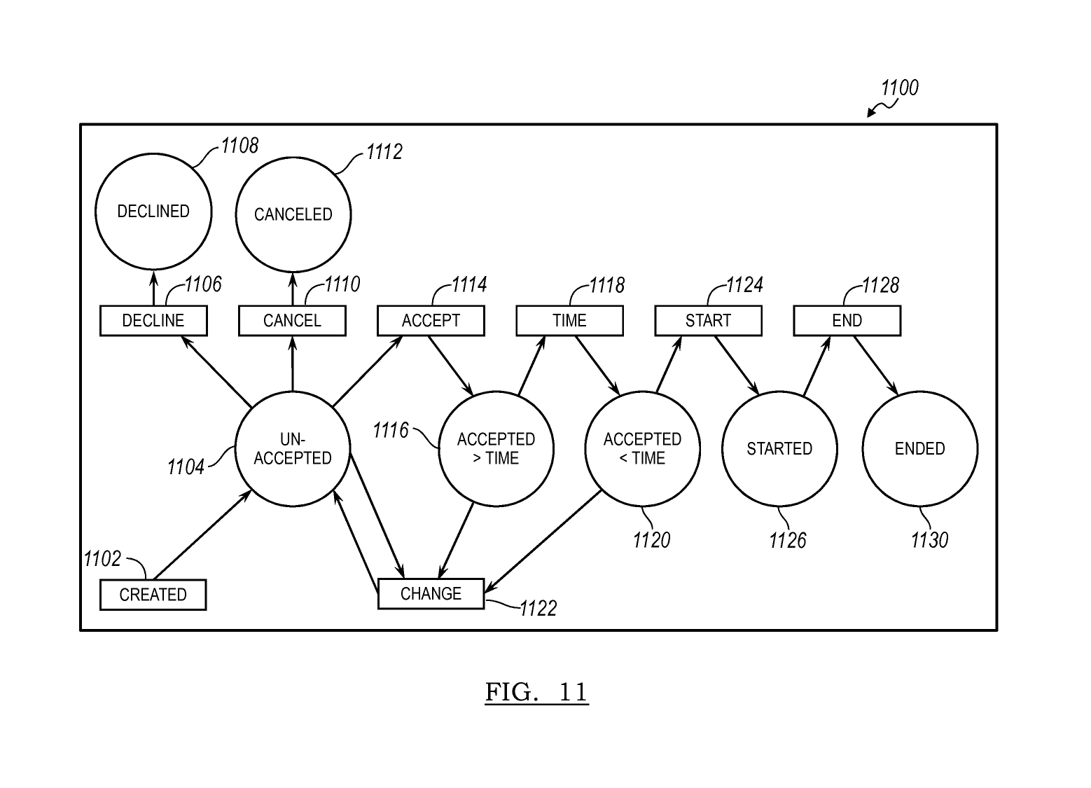

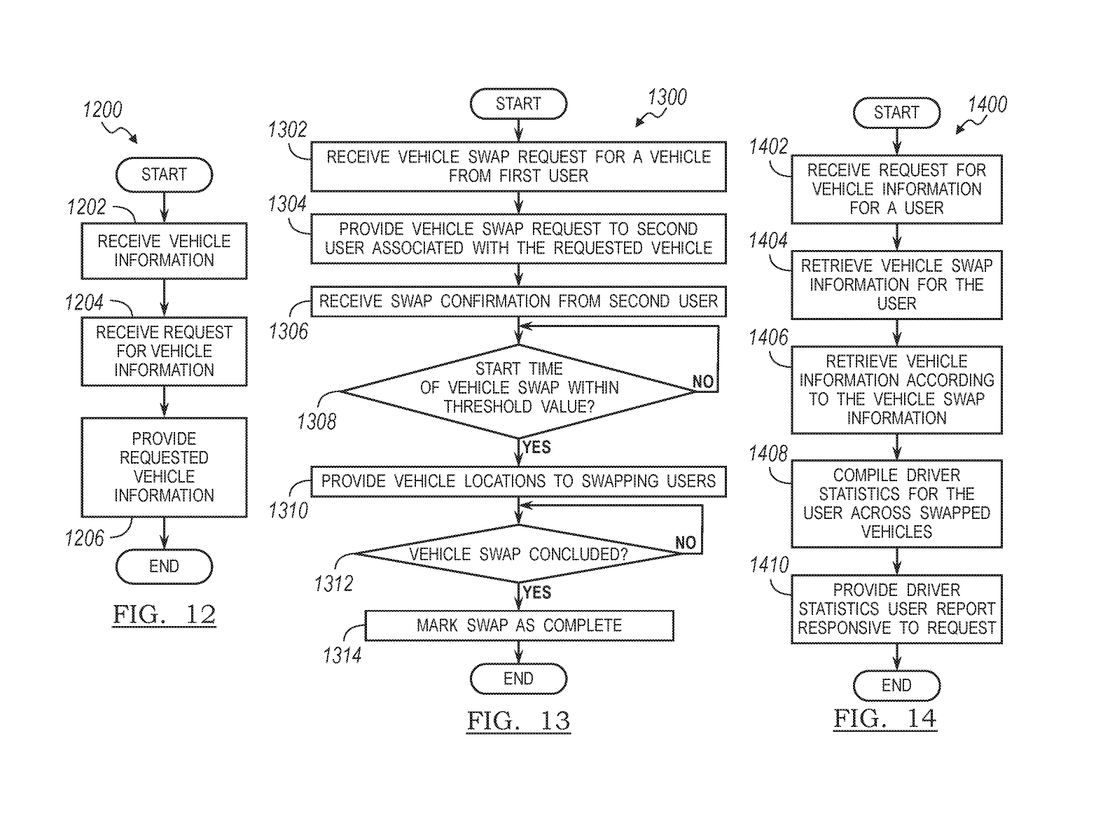

FIG. 11 illustrates an example state diagram 1100 for the swap status of a vehicle swap information 122 managed by the swap management server 118. In an example, a user may request a swap using the user interface 700 discussed in detail above. Responsive to a create action 1102 (e.g., user input to the submit request 714 of the user interface 700, the swap management server 118 may initialize a new instance of vehicle swap information 122 with a swap status of unaccepted 1104.

When the swap management server 118 receives a decline action 1106 from the recipient, the swap management server 118 may set the instance of vehicle swap information 122 to a swap status of declined 1108. When the swap management server 118 receives a cancel action 1110 from the sender, the swap management server 118 may set the instance of vehicle swap information 122 to a swap status of canceled 1112. When declined or canceled, no further action may be performed for the instance of vehicle swap information 122.

When the swap management server 118 receives an accept action 1114 from the recipient, the swap management server 118 may set the instance of vehicle swap information 122 to a swap status of accepted but outside a predetermined threshold before the time swap 1116. When a time action 1118 occurs such that the vehicle swap is within the threshold amount of time, the swap management server 118 may set the instance of vehicle swap information 122 to a swap status of accepted and within the predetermined threshold before the time swap 1120. Notably, when in the state 1120, but not in the state 1116, location information regarding the vehicles 102 indicated in the instance of vehicle swap information 122 may be available to one another.

In some cases, the swap management server 118 may receive a change action 1122 from the sender or receiver requesting alteration of the parameters of the instance of vehicle swap information 122. For example, when the instance of vehicle swap information 122 is in the one of the 1104, 1116 or 1120 states, a user may utilize the propose change control 314 of the user interface 300 and the user interface 700 to request changes to the upcoming swap. When the swap management server 118 receives a change action 1122, the swap management server 118 may set the instance of vehicle swap information 122 to a swap status of unapproved 1104, returning to (or staying in) the unaccepted state 1104.

When the swap management server 118 receives a start action 1124 from the recipient, the swap management server 118 may set the instance of vehicle swap information 122 to a swap status of started 1126. The start action 1124 may include, as some non-limiting examples, a determination by the swap management server 118 that the start time of the vehicle swap information 112 has been reached, and receipt of an indication from the user that the swap has begun.

When the swap management server 118 receives an end action 1128 from the recipient, the swap management server 118 may set the instance of vehicle swap information 122 to a swap status of ended 1130. The end action 1128 may include, as some non-limiting examples, a determination by the swap management server 118 that the end time of the vehicle swap information 112 has been reached, and receipt of an indication from the user that the swap has ended.

FIG. 11 illustrates an example process 1200 for collecting vehicle information 110. The process 1200 may be performed, for example, by the vehicle information server 116 in communication with data adapters 112 of a plurality of vehicles 102 over the network 114.

At operation 1202, the vehicle information server 116 receives vehicle information 110 from the vehicles 102. For example, the vehicle information server 116 may receive vehicle information 110 from vehicles 102 by way of the data adapters 112 accessing the vehicle buses 106. The vehicle information 110 may include location updates for the vehicle 102 and a time range during which the vehicle information 110 was collected, as well as other vehicle 102 data, such as accelerator pedal position, steering wheel angle, vehicle speed, vehicle location, vehicle identifier, and vehicle HMI information, such as steering wheel button press information. The data adapters 112 may be configured to identify the vehicles 102 by passing along a unique identifier with the vehicle information 110, such as the VIN.

At operation 1204, the vehicle information server 116 receives a request for vehicle information 110. The request may include, for example, a vehicle identifier and a time or range of time for which vehicle information 110 is being requested. In an example, the vehicle information server 116 may receive the request for vehicle information 110 from the swap management server 118.

At operation 1206, the vehicle information server 116 provides the requested vehicle information 110 to the requester. For example, the vehicle information server 116 may retrieve the vehicle information 110 received at operation 1202 and matching the received vehicle identifier and a time or range of time.

FIG. 13 illustrates an example process 1300 for performing a vehicle 102 swap. The process 1300 may be performed, for example, by the swap management server 118 in communication over the network 114 with the mobile devices 124 and the vehicle information server 116.

At operation 1302, the swap management server 118 receives a swap request for a vehicle 102 from mobile device 124 of a first user of the system 100. In an example, a user of a mobile device 124 may utilize the ride swap application 126 to request a vehicle 102 swap. The swap management server 118 may receive the request, and may store vehicle swap information 122 regarding the details of the request, such as the vehicle 102 to be requested, the start time of the requested swap, and the end time of the requested swap.

At operation 1304, the swap management server 118 sends the vehicle swap request to a mobile device 124 of a second user of the system 100 who is associated with the requested vehicle 102. In an example, the swap management server 118 may determine which user mobile device 124 should receive the swap request by determining which user's account information 120 is associated with the identifier of the vehicle 102 included in the vehicle swap information 122.

At operation 1306, the swap management server 118 receives approval of the swap request from the second user. In an example, the mobile device 124 of a second user may receive an indication from the second user approving the vehicle swap request, and may provide an indication of the approval to the swap management server 118. The swap management server 118 may accordingly set the vehicle swap information 122 form the swap to an approved state.

At operation 1308, the swap management server 118 determines whether a start time of the swap request is within a predetermined threshold. For example, the swap management server 118 may compare the start time of the vehicle swap information 122 to identify when the swap start time is within a predetermined threshold time (e.g., one hour, thirty minutes, etc.). If so, control passes to operation 1310. Otherwise, control remains at operation 1308.

At operation 1310, the swap management server 118 makes the location of the first user's vehicle 102 available to the mobile device 124 of the second user, and makes the location of the second user's vehicle 102 available to the mobile device 124 of the first user. To determine the location information, the swap management server 118 may request the vehicle locations from the vehicle information server 116 according to unique vehicle identifiers of the vehicles 102 to be swapped. Accordingly, using the location information the users may be able to readily locate the vehicles 102 to be swapped.

At operation 1312, the swap management server 118 determines whether the vehicle swap is concluded. For example, the swap management server 118 may compare the start time of the vehicle swap information 122 to identify whether the swap end time has passed. If so, control passes to operation 1314. Otherwise, control remains at operation 1312.

At operation 1314, the swap management server 118 marks the vehicle swap as complete. For example, the swap management server 118 may update the vehicle swap information 122 for the current swap to indicate a swap status of ended or complete. After operation 1314, the process 1300 ends.

FIG. 14 illustrates an example process 1400 for providing driver statistics across swapped vehicles 102. The process 1400 may be performed, for example, by the swap management server 118 in communication over the network 114 with the vehicle information server 116.

At operation 1402, the swap management server 118 receives a request for vehicle 102 information for a user. For example, the request may include a unique identifier of a user according to the user's account information 120, and in some cases a time period of user activity for which to receive driver statistics.

At operation 1404, the swap management server 118 retrieves vehicle swap information 122 for the user. For example, the swap management server 118 may identify the vehicle swaps performed by the specified user by querying the vehicle swap information 122 for completed vehicle swaps overall or, if specified, during the requested time period.

At operation 1406, the swap management server 118 retrieves vehicle information 110 according to vehicle 102 identifiers and times specified by the vehicle swap information 122. Accordingly, the vehicle swap information 122 may allow the swap management server 118 to determine which vehicle information 110 is associated with driver activity of the specified user across vehicles 102.

At operation 1408, the swap management server 118 compiles driver statistics for the user across the vehicles 102. Accordingly the swap management server 118 may create statistics across the vehicles 102 of the system 100 with respect to the driving habits of the user. At operation 1410, the swap management server 118 sends the driver statistics to the requester. After operation 1410, the process 1400 ends.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a ride-swap server configured to
receive locations of first and second vehicles; and
when vehicle swap information indicates a pending vehicle swap between a first vehicle assigned to a first user and a second vehicle assigned to a second user, provide a location of the first vehicle to a mobile device of the second user and provide a location of the second vehicle to a mobile device of the first user.

2. The system of claim 1, wherein the ride-swap server is further configured to determine the vehicle swap as pending according to a start time of the vehicle swap being within a predetermined amount of time from a current time.

3. The system of claim 1, wherein the first vehicle and the second vehicle are members of a common vehicle fleet.

4. The system of claim 1, wherein the ride-swap server is further configured to:
request the location of the first vehicle and the location of the second vehicle from a vehicle information server configured to maintain vehicle location information for a plurality of vehicles; and
receive the location of the first vehicle and the location of the second vehicle from the vehicle information server responsive to the request.

5. The system of claim 4, wherein the vehicle information server is further configured to receive vehicle information logged from the first vehicle and the second vehicle, wherein the vehicle information includes vehicle location information.

6. The system of claim 4, wherein the vehicle information server is further configured to at least one of:
receive a first confirmation from the mobile device of the first user that the first user has swapped to the second vehicle; and
receive a second confirmation from the mobile device of the second user that the second user has swapped to the first vehicle.

7. The system of claim 6, wherein the vehicle information server is further configured to update the vehicle swap information to indicate that the first user and the second user have swapped vehicles.

8. The system of claim 7, wherein the vehicle information server is further configured to:
identify, according to the vehicle swap information, first vehicle information received from the first vehicle when assigned to the first user;
identify, according to the vehicle swap information, second vehicle information received from the second vehicle when assigned to the first user; and
compile driving statistics for the first user across the first vehicle and the second vehicle based on the first vehicle information and the second vehicle information.

9. A system comprising:
a vehicle information server configured to
receive vehicle information from a plurality of vehicles;
identify, according to vehicle swap information, a start indication of a user swapping from a first vehicle to a second vehicle; and
compile driving statistics for the user using the vehicle information from the first vehicle before the start indication and from the second vehicle after the start indication.

10. The system of claim 9, wherein the start indication of the user swapping from the first vehicle to the second vehicle is determined according to one of swap start time of the vehicle swap information and receipt of input from the user that the swap has begun.

11. The system of claim 9, wherein the vehicle information server is further configured to compile driving statistics for a second user using the vehicle information from the second vehicle before the start indication and from the first vehicle after the start indication.

12. The system of claim 9, wherein the vehicle information server is further configured to compile driving statistics for the user using the vehicle information from the first vehicle after an end indication of a user swapping from the second vehicle back to the first vehicle.

13. The system of claim 12, wherein the end indication of a user swapping from the second vehicle back to the first vehicle is determined according to one of swap end time of the vehicle swap information and receipt of input from the user that the swap has ended.

14. A system comprising:
a mobile device associated with a user account and configured to
send, to a server, an acceptance of a vehicle swap, the swap describing a trade of a vehicle associated with the user account with a second vehicle associated with a second user account; and
display a location of the second vehicle received from the server when a start time of the swap is within a predetermined threshold from a current time.

15. The system of claim 14, wherein the mobile device is further configured to receive a request to swap the vehicle from a server configured to maintain vehicle swap information.

16. The system of claim 14, wherein the server is further configured to receive the location of the second vehicle from a data adapter connected to a port of a vehicle network of the second vehicle.

17. The system of claim 14, wherein the mobile device is further configured to send, to the server, a confirmation that a user associated with the user account has swapped to the second vehicle.

18. The system of claim 17, wherein the mobile device is further configured to send, to the server, a second confirmation that the user has swapped back to the vehicle from the second vehicle.

19. The system of claim 14, wherein the predetermined threshold is one hour.
